(19) United States
(12) Patent Application Publication
(10) Pub. No.: US 2014/0253540 A1
(43) Pub. Date: Sep. 11, 2014

(54) METHOD AND SYSTEM OF INCORPORATING REAL WORLD OBJECTS INTO A VIRTUAL ENVIRONMENT

(71) Applicants: Yoav DORI, Tel-Aviv (IL); Alon Shakked, Yehud (IL); Mor SHANI, Tel-Aviv (IL); Ben Klipper, Holon (IL)

(72) Inventors: Yoav DORI, Tel-Aviv (IL); Alon Shakked, Yehud (IL); Mor SHANI, Tel-Aviv (IL); Ben Klipper, Holon (IL)

(21) Appl. No.: 13/789,429

(22) Filed: Mar. 7, 2013

(51) Int. Cl. G06T 19/00

(52) U.S. Cl. CPC G06T 19/006
USPC 345/419; 345/633

(57) ABSTRACT

A system for incorporating physical objects into a virtual environment is provided herein. The system includes one or more capturing devices configured to capture physical objects located on a surface; an image enhancing module configured to manipulate the captured image to facilitate distinguishing the physical objects from the surface; an image processing module configured to extract outline of each one of the physical objects; a polygon generator configured to generate a polygon for each one of the physical objects; and a display control module configured to combine the polygons with virtual objects in accordance with predefined rules of a virtual environment.

### FIELD OF THE INVENTION

The present invention relates generally to systems and methods of detecting and identifying real world objects, and in particular to an interactive game incorporating real world objects into a virtual game.

### BACKGROUND OF THE INVENTION

Today's era is full of technology based devices, and in particular screen oriented, with a Graphic User Interface, and user input methods such as keyboards, mouse, track-pad, touch-screen and the like. These devices include desktops computers, laptops, smart-phones and tablets with touch-screens and other input methods. Most notable advances in this field include the Nintendo Wii™ and Microsoft Kinect™ and similar products that have a motion-based controller capable of inputting data of 3D space movements of a user.

There is an ongoing need to bridge the gap between real physical interactions and virtual computerized interfaces. Children in particular are much more exposed to computerized interactions, and at much earlier ages than in the past, due to the huge upscale in computing availability in recent years. A very important aspect in child development is gaining significant amount of tangible experiences, and exploring by touch the world around them. This increases the urgency of creating consumer available devices that can contribute to both the computerized and the tangible experiences of children.

### SUMMARY OF THE INVENTION

According to one embodiment of the present invention, there is provided a system for incorporating physical objects into a virtual environment. The system includes one or more capturing devices configured to capture physical objects located on a surface; an image enhancing module configured to manipulate the captured image to facilitate distinguishing the physical objects from the surface; an image processing module configured to extract outline of each one of the physical objects; a polygon generator configured to generate a polygon for each one of the physical objects; and a display control module configured to combine the polygons with virtual objects in accordance with predefined rules of a virtual environment.

According to another aspect of the present invention, there is provided a method for incorporating physical objects into a virtual environment. The method includes the following steps: capturing physical objects located on a surface; manipulating the captured image to facilitate distinguishing the physical objects from the surface; extracting outline of each one of the physical objects; generating a polygon for each one of the physical objects; and combining the polygons with virtual objects in accordance with predefined rules of a virtual environment.

These additional, and/or other aspects and/or advantages of the present invention are set forth in the detailed description which follows.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

Examples illustrative of embodiments of the invention are described below with reference to the figures attached hereto. In the figures, identical structures, elements or parts that appear in more than one figure are generally labeled with the same number in all the figures in which they appear. Dimensions of components and features shown in the figures are generally chosen for convenience and clarity of presentation and are not necessarily shown to scale.

FIG. 1 is a high level schematic block diagram illustrating a system according to the present invention;

FIG. 2 is a high level flowchart diagram illustrating an aspect of a method according to some embodiments of the present invention;

FIG. 3 is a perspective view illustrating another aspect of a method according to some embodiments of the present invention; and

FIG. 4 is a perspective view illustrating yet another aspect of a method according to some embodiments of the present invention.

The drawings together with the following detailed description make the embodiments of the invention apparent to those skilled in the art.

### DETAILED DESCRIPTION OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments or of being practiced or carried out in various ways. Also, it is to be understood that the phraseology and terminology employed herein is for the purpose of description and should not be regarded as limiting.

Embodiments of the present invention may be related to an interactive game incorporating real world objects into a virtual game, or alternatively, without limitations to any software application that may include any type of graphical user interface.

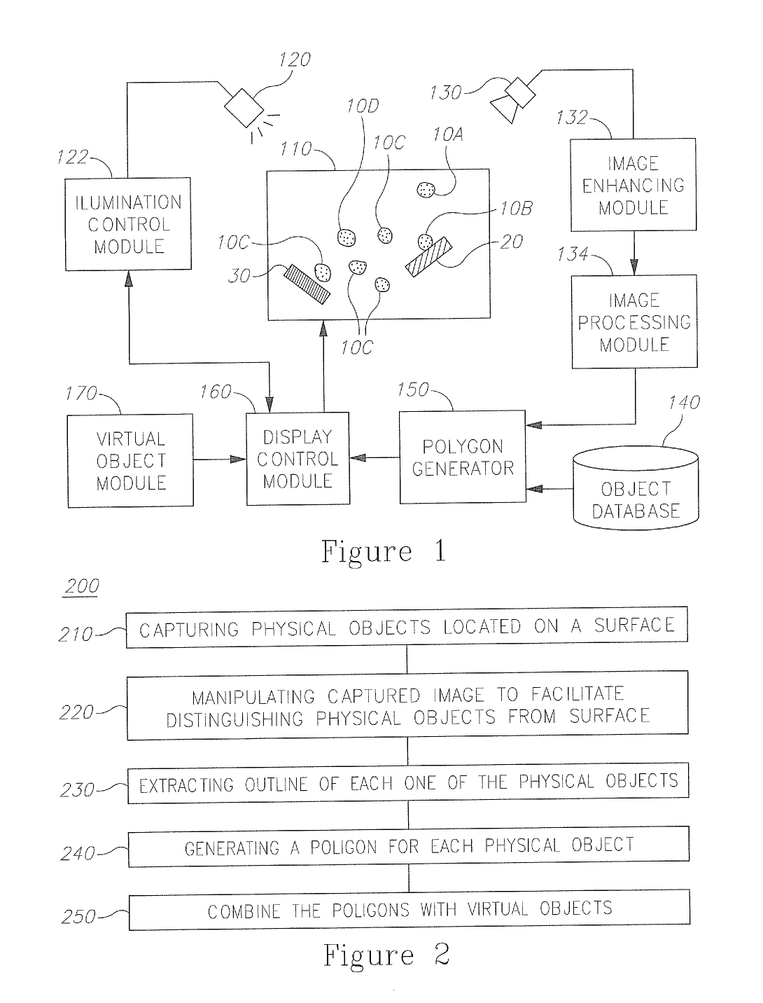

FIG. 1 is a block diagram of the overall system 100 according to some embodiments of the present invention. System 100 includes at least one capturing device 130 configured to capture physical objects such as 20 and 30 located on a surface 110. System 100 further includes an image enhancing module 132 configured to manipulate the captured image to facilitate distinguishing physical objects 20 and 30 from surface 110. System 100 further includes an image processing module 134 configured to extract outline of each one of physical objects 20 and 30. System 100 further includes a polygon generator 150 configured to generate a polygon for each one of physical objects 20 and 30. System 100 further includes a display control module 160 configured to combine the polygons with virtual objects 10A-10G in accordance with predefined rules of a virtual environment.

In this particular example, the virtual scene contains balls 10A-10G which are made to bounce off the real world objects 20 and 30. This is an example interactive game configured into the computer and software and displayed over surface 110. The game may be controlled by the player using body gestures to control the game-play on the displayed surface or above it, as well as using different objects placed on the surface. One example may be a game that projects a virtual ball that is subject to laws of gravity, a visible virtual target that the ball needs to hit, and a virtual button, all configured into the computer and software. Once the virtual button is pressed by the user, by touching the surface on the designated button area, the ball is released and falls towards the bottom of the image as if it was falling. In order to finish levels, the ball needs to hit the target. If the target isn't directly underneath the ball, it won't be able to hit the target. In this case, a real physical object may be placed on the projected image in the ball's course of movement.

As explained above, system 100 may detect physical objects 20 and 30 placed on the surface, and for example inserts their shape into the game. The result of this is that the virtual game now has another element in it, besides the ball and target and button, which element is in the shape of the object that was placed on the surface. In this case, when the button is pressed again, the ball starts to move on its course, and when reaching the object placed, it changes course, as if hitting the object. In this way, the ball may be redirected to the target.

Another addition may be the use of different materials. An example would be placing an object made of rubber on the surface. The computer may be configured to recognize that the object is made of rubber and when inserting it into the game, the computer may add attributes like making it more bouncy than other objects in the game. In this example, when the ball is released and reaches the rubber object it is sprung off of it, instead of just hitting it. Another example may be placing a magnet, so when the ball is released it is attracted to the magnet object in the game.

In a further embodiment, the material of the real world object is determined. This is done using the bidirectional reflectance distribution function (BRDF) where fᵣ(ωᵢ, ωₒ)) is a four-dimensional function that defines how light is reflected at an opaque surface. The function takes an incoming light direction, ωᵢ, and outgoing direction, ωₒ, both defined with respect to the surface normal n, and returns the ratio of reflected radiance exiting along ωₒ to the irradiance incident on the surface from direction ωᵢ. Each direction ω is itself parameterized by azimuth angle φ and zenith angle θ, therefore the BRDF as a whole is 4-dimensional. The BRDF has units sr-1, with steradians (sr) being a unit of solid angle. Diagram showing vectors used to define the BRDF. All vectors are unit length. ωᵢ points toward the light source. ωₒ points toward the viewer (camera). n is the surface normal.

$${f}_{r} ( {ω}_{i} , {ω}_{o} ) = \frac{d {L}_{r} ( {ω}_{o} )}{d {E}_{i} ( {ω}_{i} )} = \frac{d {L}_{r} ( {ω}_{o} )}{{E}_{i} ( {ω}_{i} ) cos {θ}_{i} d {ω}_{i}}$$

where Lr is the radiance, E is the irradiance, and θi is the angle made between ωᵢ and the surface normal, n.

According to some embodiments of the invention, detection of more than just physical characteristics may be possible. The detection may further include: color within the polygon, area of the polygon, perimeter of the polygon, length attributes inside the polygon, length between vertexes, angles within the polygon.

Optionally, the method may include the step of manipulating certain objects that are recognized by the system to obtain characteristics, which may affect the game/software differently than other objects. In other words, obtaining predetermined data on some specific objects, and when these objects are recognized they react or behave in the system differently. A second option is to directly measure any of the aforementioned characteristics so that the physical objects may be distinguished in terms of behavior and reactions.

According to some embodiments of the invention, image enhancing module 132 manipulates the captured image by changing hue saturation value (HSV) levels of the captured image. Alternatively, the HSV manipulating may be replaced by an equivalent LAB color space manipulation This manipulation is being enabled by illuminating surface 110 using illuminator 120 that is controlled by illumination control module 122 so that the hue of the illumination is significantly weaker than the hue of the physical objects 20 and 30. Alternatively, physical objects 20 and 30 may be selected with a significantly high hue.

In a different embodiment, infra red (IR) illumination may be used to distinguish the objects from the background. This may be carried out as follows: The spectrum of colors that the human eye can see is from violet (400 nm wavelength) to red (700 nm wavelength). Any light wave of length that is below or above that cannot be seen by humans. Above that spectrum is the Infrared light spectrum.

One method to eliminate the content that is displayed beneath the objects is to use infrared lighting: First, a pass filter on the sensor is used for blocking the visible light spectrum. This will make the displayed content beneath the objects invisible to the sensor. Then, the scene is illuminated using infrared light. The infrared light will be reflected from the scene just like regular light and will be “seen” by the sensor. This way, we get an image containing the amount of reflected infrared light from every point in the scene.

We can then run an edge detection algorithm, and since the background cannot be seen, the resulting edges would be only the objects' outlines.

According to some embodiments of the invention, display control module 160 displays over the surface an interaction between the virtual objects and the physical objects that are represented by corresponding polygons in the virtual environment.

According to some embodiments of the invention, the virtual environment is a game or a software application that includes graphical user interface. The virtual environment is displayed upon the surface either by illuminator 120 being controlled by illumination control module 122 or being displayed via surface 110 itself in the case in which surface 110 is an electronic display. The virtual environment may be a still or moving image that is the user interface. There are many ways in which the user may interact with the system and interface. The first method may be using tangible objects. Placing, moving, turning or orienting objects on surface 110 (or above or around the surface), and other possible interactions performed with the objects that are described below. These objects may be pre-determined and included with the system such as in object database 140, or undetermined foreign objects.

The second method may be using human gestures, that may include finger or hand or body gestures, or by using a pointer apparatus. These gestures may be performed on the surface by touching it, possibly in specific places, and other multi-touch gestures, or by performing gestures above or around the surface. The third method may be using other types of input, such as specific or nonspecific sound or temperature that is detected by the system.

According to some embodiments of the invention, image processing module 134 detects physical characteristics of the physical objects and applying the detected physical characteristics in an interaction between the physical objects and the virtual objects in the virtual environment.

According to some embodiments of the invention, image processing module 134 detects a type of material of the physical objects by applying a bidirectional reflectance distribution function to the captured image.

According to some embodiments of the invention, image processing module 134 extracts the outline of each one of the physical objects by applying at least one blob analysis algorithm.

According to some embodiments of the invention, image processing module 134 extracts the outline of each one of the physical objects by applying at least one edge detection algorithm.

FIG. 2 is a high level flowchart diagram illustrating an aspect of a method according to some embodiments of the present invention. It should be noted that method 200 is not limited to the aforementioned architecture of system 100 and that other implementations may be used for carrying out the logic of method 200. Method 200 starts with the step of capturing physical objects located on a surface 210. It then goes on to manipulating the captured image to facilitate distinguishing the physical objects from the surface 220. The method then proceeds to extracting outline of each one of the physical objects 230. Then the method goes on to the step of generating a polygon for each one of the physical objects 240. The method then proceeds to combining the polygons with virtual objects in accordance with predefined rules of a virtual environment 250.

According to some embodiments of the present invention, the manipulating step 220 is carried out by changing HSV or LAB levels of the captured image.

According to some embodiments of the present invention, the capturing step 210 comprises a 3D mapping of the objects, wherein the manipulating comprises applying a threshold indicative of height above the surface of the physical objects.

According to some embodiments of the present invention, the manipulating step 220 is carried out by illuminating below the surface with a polarized light having a specified polarization and wherein the capturing further comprises applying a polarized filter having a polarization that is approximately 90° rotated to the specified polarization so that in the captured image the light coming from the surface is blocked.

According to some embodiments of the present invention, method 200 further includes a step of displaying over the surface an interaction between the virtual objects and the physical objects that are represented by corresponding polygons in the virtual environment.

According to some embodiments of the present invention, method 200 further includes a step of detecting physical characteristics of the physical objects and applying the detected physical characteristics in an interaction between the physical objects and the virtual objects in the virtual environment.

According to some embodiments of the present invention, method 200 further includes a step of detecting a type of material of the physical objects by applying a bidirectional reflectance distribution function to the captured image.

According to some embodiments of the present invention, the extracting step 230 is carried out by applying blob analysis or by applying one or more edge detection algorithms.

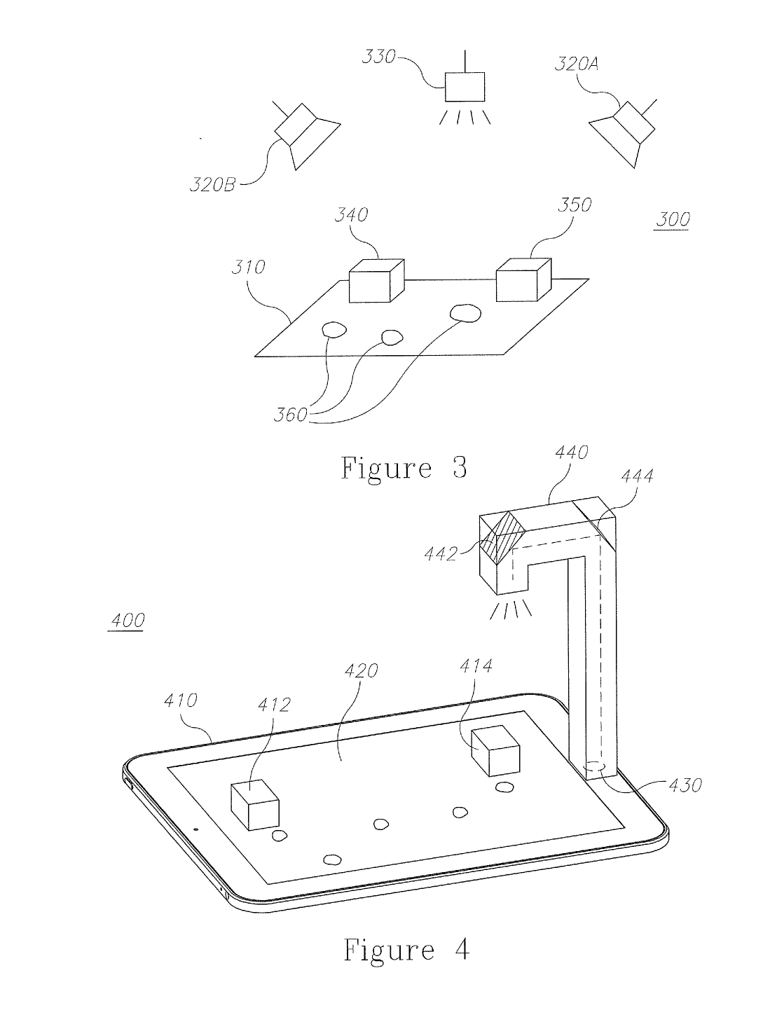

FIG. 3 is a perspective view illustrating another aspect of a system according to some embodiments of the present invention. In system 300, capturing devices 320A and 320B provide a 3D mapping of the real world (physical) objects 340 and 350, wherein the image enhancing module manipulates the captured image by applying a threshold indicative of height above the surface 310 of the physical objects. Illuminator 330 then projects virtual objects 360 over surface 310 while real world objects 340 and 350 are incorporated into the virtual environment of virtual objects 360.

FIG. 4 is a perspective view illustrating yet another aspect of a system 400 according to some embodiments of the present invention. In this embodiment, surface 420 is an electronic display of, for example, a tablet device 410. Surface 420 illuminates in a polarized light having a specified polarization. The real world objects 412 and 414 naturally obscure the polarized light as they are placed on surface 420. The built-in camera 430 captures surface 420 via periscope 440 which folds using, for example, mirrors 442 and 444, the image into camera 430. It should be noted that periscope 440 may be implemented with one mirror or any other number of mirrors for folding the image onto camera 430.

In a preferred embodiment, a polarizing filter (not shown) is located somewhere along the optical path coming from surface 420 and onto camera 430 via periscope 440 (e.g., coupled to camera 430, though periscope 440, and attached to any of folding mirrors 442 and 444). Specifically, the polarized filter has a polarization that is approximately 90° rotated to the specified polarization (of the LCD). Then, when camera image enhancing module which is located within tablet 410 receives the polarized image, any light coming directly from surface 420 is blocked. It is then an easy task to distinguish the blocked surface from the non-blocked real world objects. It is understood that many other methods for distinguishing surface from real world objects may be used. Alternatively, where a screen that is not polarized is used, a polarizing filter can be added on top of it to achieve the aforementioned effect of the tablet screen.

When implementing the invention using a tablet having a touch screen, it would be advantageous to protect the touch screen with any protective surface (such as a transparent acrylic material). However, as the protective surface disables the touch screen feature, several alternatives should be provided. One such alternative is the use of capacitive buttons on any location that provides a graphical user interface which is touch-sensitive. The capacitive button can be in a form of a knob, a roller, a switch and the like.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
capturing physical objects located on a surface usable as a display;
manipulating the captured image to facilitate distinguishing the physical objects from the surface;
extracting outline of each one of the physical objects;
generating a polygon for each one of the physical objects; and
combining the polygons with virtual objects in accordance with predefined rules of a virtual environment, for interaction between the physical objects and the virtual object on the display.

2. The method according to claim 1, wherein the manipulating is carried out by changing color attributes of the captured image according to a predefined color space.

3. The method according to claim 1, wherein the capturing comprises a 3D mapping of the objects, wherein the manipulating comprises applying a threshold indicative of height above the surface of the physical objects.

4. The method according to claim 1, wherein the manipulating is carried out by illuminating below the surface with a polarized light having a specified polarization and wherein the capturing further comprises applying a polarized filter having a polarization that is approximately 90° rotated to the specified polarization so that in the captured image the light coming from the surface is blocked.

5. The method according to claim 1, further comprising displaying over the surface an interaction between the virtual objects and the physical objects that are represented by corresponding polygons in the virtual environment.

6. The method according to claim 1, wherein the virtual environment is a game or a software application that includes graphical user interface.

7. The method according to claim 1, further comprising detecting physical characteristics of the physical objects and applying the detected physical characteristics in an interaction between the physical objects and the virtual objects in the virtual environment.

8. The method according to claim 1, further comprising detecting a type of material of the physical objects by applying a bidirectional reflectance distribution function to the captured image.

9. The method according to claim 1, wherein the extracting of the outline of each one of the physical objects is carried out by applying at least one blob analysis algorithm.

10. The method according to claim 1, wherein the extracting of the outline of each one of the physical objects is carried out by applying at least one edge detection algorithm.

11. A system comprising:
at least one image capturing device configured to capture physical objects located on a surface usable as a display;
an image enhancing module configured to manipulate the captured image to facilitate distinguishing the physical objects from the surface;
an image processing module configured to extract outline of each one of the physical objects;
a polygon generator configured to generate a polygon for each one of the physical objects; and
a display control module configured to combine the polygons with virtual objects in accordance with predefined rules of a virtual environment, for interaction between the physical objects and the virtual object on the display.

12. The system according to claim 11, wherein the manipulating is carried out by changing color attributes of the captured image according to a predefined color space.

13. The system according to claim 11, wherein the capturing devices provide a 3D mapping of the objects and wherein the image enhancing module manipulates the captured image by applying a threshold indicative of height above the surface of the physical objects.

14. The system according to claim 11, wherein the surface is an electronic display illuminating in a polarized light having a specified polarization, wherein the system further comprises a polarized filter located along the optical path coming from the surface onto the capturing device, having a polarization that is approximately 90° rotated to the specified polarization so that in the captured image the light coming from the surface is blocked.

15. The system according to claim 11, wherein the display control module displays over the surface an interaction between the virtual objects and the physical objects that are represented by corresponding polygons in the virtual environment.

16. The system according to claim 11, wherein the image processing module detects physical characteristics of the physical objects and applies the detected physical characteristics in an interaction between the physical objects and the virtual objects in the virtual environment.

17. The system according to claim 11, wherein the image processing module detects a type of material of the physical objects by applying a bidirectional reflectance distribution function to the captured image.

18. The system according to claim 11, wherein the image processing module extracts the outline of each one of the physical objects by applying at least one blob analysis algorithm.

19. The system according to claim 11, wherein the image processing module extracts the outline of each one of the physical objects by applying at least one edge detection algorithm.

20. The system according to claim 11, further comprising a periscope comprising one or more mirrors configured to fold an optical path coming from the surface into the image capturing device.
